(19) United States
(12) Patent Application Publication
(10) Pub. No.: US 2013/0197947 A1
(43) Pub. Date: Aug. 1, 2013

(54) METHOD AND SYSTEM FOR GRAPHICALLY DISPLAYING INSURANCE COVERAGE INFORMATION

(71) Applicant: Jared D. Carillo, Windsor Locks, CT (US)

(72) Inventor: Jared D. Carillo, Windsor Locks, CT (US)

(21) Appl. No.: 13/749,849

(22) Filed: Jan. 25, 2013

Related U.S. Application Data
(60) Provisional application No. 61/591,608, filed on Jan. 27, 2012.

(51) Int. Cl. G06Q 40/08

(52) U.S. Cl. CPC G06Q 40/08
USPC 705/4

(57) ABSTRACT

Systems and methods for graphically displaying insurance coverage information are provided. The systems and methods include accessing insurance policy information about an insuree in a coverage database, determining, with reference to the insurance policy information, at least one type of coverage available to the insuree, identifying a graphical indicator associated with the at least one type of coverage available to the insuree, and displaying the graphical indicator.

### RELATED APPLICATIONS

This application claims priority under 35 U.S.C. §119(e) to U.S. Provisional Application No. 61/591,608, entitled “METHOD AND SYSTEM FOR GRAPHICALLY DISPLAYING INSURANCE COVERAGE INFORMATION,” filed on Jan. 27, 2012, which application is incorporated herein by reference in its entirety.

### BACKGROUND

Many companies offer insurance policies describing the types of coverage available to and maintained by the insuree. These insurance policies are often several pages long, and generally present this coverage information in language intended to be legally binding.

### SUMMARY

As a result, it is realized that many customers seeking insurance cannot determine what types of coverage are being provided through the policy, what types of coverage are available, or what types of coverage have been declined. It is realized that systems and methods that synthesize coverage information into a graphical report that summarizes available coverage and elected coverage, as well as options that were declined. According to one embodiment, it would be beneficial to provide insurees and others related to an insurance policy with a graphical report of the insurance coverages associated with the policy. Such a graphical report would allow insurees to determine quickly what type of insurance they currently have, and to identify additional types of coverage available to them. In further embodiments, the graphical report is configured to communicate the context of coverages provided to the user. The graphical report can also allow the user to understand what coverage are unavailable in a given context. In other words, what risks are not insurable in the current context. In some embodiments, a system element can be configured to accept user selection to contact an insurance agent/agency to discuss desired coverages that are currently unavailable and how they might be obtained.

According to one aspect, a computer implemented method for graphically displaying insurance coverage information is provided. The method comprises accessing, by a computer system, insurance policy information about an insuree in a coverage database, determining, by the computer system, with reference to the insurance policy information, at least one type of coverage available to the insuree, identifying, by the computer system, a graphical indicator associated with the at least one type of coverage available to the insuree, and displaying, by the computer system, the graphical indicator.

According to one embodiment, the act of accessing insurance policy information about an insuree in a coverage database comprises accessing insurance policy information over a computer network. According to one embodiment, the method further comprises generating a coverage report displaying the graphical indicator. According to one embodiment, the act of generating the coverage report displaying the graphical indicator comprises acts of: responsive to the insuree maintaining the type of coverage associated with the graphical indicator, displaying the graphical indicator in a first region, and responsive to the insuree not maintaining the type of coverage associated with the graphical indicator, displaying the graphical indicator in a second region.

According to one embodiment, the method further comprises transitioning graphical indicator between the first and second regions responsive to user selection in a user interface. According to one embodiment, the method further comprises an act of displaying the coverage report on a display device of a computer. According to one embodiment, the method further comprises printing the coverage report.

According to one embodiment, the method further comprises the graphical indicator including an image reflective of a type of coverage. According to one embodiment, generating the graphical indicator includes summarizing available coverage information as part of the graphical indicator. According to one embodiment, summarizing the available coverage information includes providing a display color for the graphical indicator reflective of a level of coverage. According to one embodiment, the method further comprises determining that the level of coverage being displayed meets a threshold associated with a current user. According to one embodiment, the method further comprises determining that the level of coverage being displayed meets a level of coverage for the same coverage type being offered by another servicer.

According to one embodiment, the method further comprises determining a threshold level of coverage for a plurality of coverage types based on demographic information associated with a current user. According to one embodiment, the graphical indicator comprises a graphical icon indicating a level of coverage of the type of coverage associated with the graphical indicator. According to one embodiment, the color of the graphical indicator indicates the level of coverage.

According to one aspect, a computer system for graphically displaying insurance coverage information is provided. The system comprises an access processor configured to access insurance policy information about an insuree in a coverage database, a coverage processor configured to determine, with reference to the insurance policy information, at least one type of coverage available to the insure, a graphical indicator identification processor configured to identify a graphical indicator associated with the at least one type of coverage available to the insure, and a graphical indicator display processor configured to display the graphical indicator.

According to one embodiment, the access processor is configured to access insurance policy information over a computer network. According to one embodiment, the coverage processor is configured to generate a coverage report displaying the graphical indicator. According to one embodiment, the coverage processor is configured to generate the coverage report responsive to the insuree maintaining the type of coverage associated with the graphical indicator, having the graphical indicator displayed in a first region, and responsive to the insuree not maintaining the type of coverage associated with the graphical indicator, having the graphical indicator displayed in a second region.

According to one embodiment, the coverage processor is configured to transition the graphical indicator between the first and second regions responsive to user selection in a user interface. According to one embodiment, the coverage processor is configured to display the coverage report on a display device of a computer. According to one embodiment, the coverage processor is configured to generate a printable image of the coverage report. According to one embodiment, the graphical indicator display processor is configured to generate the graphical indicator including an image reflective of a type of coverage. According to one embodiment, the graphical indicator display processor is configured to summarize available coverage information as part of the graphical indicator. According to one embodiment, the graphical indicator display processor is configured to provide a display color for the graphical indicator reflective of a level of coverage to summarize the available coverage information.

According to one embodiment, the coverage process is configured to determine that the level of coverage being displayed meets a threshold associated with a current user. According to one embodiment, the coverage process is configured to determine that the level of coverage being displayed meets a level of coverage for the same coverage type being offered by another servicer. According to one embodiment, the coverage process is configured to determine a threshold level of coverage for a plurality of coverage types based on demographic information associated with a current user.

According to one embodiment, the graphical indicator display processor is configured to generate the graphical indicator such that the graphical indicator comprises a graphical icon indicating a level of coverage of the type of coverage associated with the graphical indicator. According to one embodiment, the graphical indicator display processor is configured to generate the graphical indicator such that the color of the graphical indicator indicates the level of coverage. According to one embodiment, the system further comprises a database configured to store insurance coverage information.

According to one aspect, a non-transitory computer-readable medium comprising computer-executable instructions that, when executed on a processor of a server, perform a method for graphically displaying insurance coverage information is provided. The method comprises accessing insurance policy information about an insuree in a coverage database, determining, with reference to the insurance policy information, at least one type of coverage available to the insure, identifying a graphical indicator associated with the at least one type of coverage available to the insuree, and displaying the graphical indicator.

According to one embodiment, accessing insurance policy information about an insuree in a coverage database comprises accessing insurance policy information over a computer network. According to one embodiment, the method further comprises generating a coverage report displaying the graphical indicator. According to one embodiment, system of generating the coverage report displaying the graphical indicator comprises acts of: responsive to the insuree maintaining the type of coverage associated with the graphical indicator, displaying the graphical indicator in a first region, and responsive to the insuree not maintaining the type of coverage associated with the graphical indicator, displaying the graphical indicator in a second region.

According to one embodiment, the method further comprises transitioning graphical indicator between the first and second regions responsive to user selection in a user interface. According to one embodiment, the method further comprises an act of displaying the coverage report on a display device of a computer. According to one embodiment, the method further comprises printing the coverage report.

According to one embodiment, the method further comprises the graphical indicator including an image reflective of a type of coverage. According to one embodiment, generating the graphical indicator includes summarizing available coverage information as part of the graphical indicator. According to one embodiment, summarizing the available coverage information includes providing a display color for the graphical indicator reflective of a level of coverage. According to one embodiment, the method further comprises determining that the level of coverage being displayed meets a threshold associated with a current user. According to one embodiment, the method further comprises determining that the level of coverage being displayed meets a level of coverage for the same coverage type being offered by another servicer.

According to one embodiment, the method further comprises determining a threshold level of coverage for a plurality of coverage types based on demographic information associated with a current user. According to one embodiment, the graphical indicator comprises a graphical icon indicating a level of coverage of the type of coverage associated with the graphical indicator. According to one embodiment, the color of the graphical indicator indicates the level of coverage.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence, are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 depicts a flow chart of a method for graphically displaying insurance coverage according to an embodiment;

FIG. 2 illustrates an example report for graphically displaying insurance coverage according to an embodiment;

FIG. 3 depicts a flow chart of a method in accordance with an embodiment;

FIG. 4 shows an example implementation according to an embodiment;

FIG. 5 depicts an example system upon which various aspects of the present embodiments may be implemented; and

FIG. 6 illustrates an example comparison view, according to one embodiment.

### DETAILED DESCRIPTION

As discussed above, there is a need to provide insurees and others related to an insurance policy with a graphical report of the insurance coverages associated with the policy. Such a graphical report would allow insurees to easily determine what type of insurance they currently have, and to identify additional types of coverage available to them.

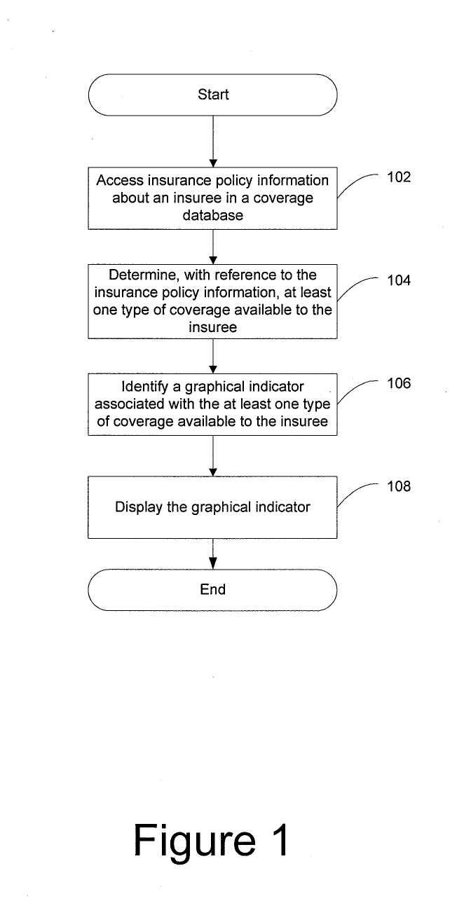

FIG. 1 shows a flowchart of a process 100 for providing a graphical report of the insurance coverages associated with the policy. The process 100 begins at step 102, where insurance policy information about an insuree is accessed in a coverage database. The insurance policy information may include the name of the insuree, types and amounts of coverage in the insuree's policy, types and amounts of coverage available to the insuree, and the term of coverage for each policy. The insurance policy information may also include types and amounts of coverage previously held by the insuree, but allowed to lapse.

According to some embodiments, coverage information may be automatically retrieved by a computer system, for example, a computer system executing process 100. The computer system can automatically retrieve from one or more sources coverage information, such as a coverage database provided by an insurer, an API, or other interface type. The coverage information may be scanned from an existing policy and mapped into categories and may be represented graphically by the computer system. In some embodiments, the computer system can access online data, including policy information from publically available web sites. In other embodiments, the computer system can accept authorization information from a user to obtain user specific policy information from an insurance service web site. Further, the computer system may be adapted to render a graphical representation of more than one policy. For instance, more than one policy may be represented together graphically so they may be easily compared.

In some embodiments, the insurance policy information may be accessed over a computer network, for example, the Internet. In other embodiments, the insurance policy information may be accessed from a local database.

At step 104, at least one type of coverage available to the insuree is determined with reference to the insurance policy information. In some examples, coverages may relate to a risk or casualty being insured against or costs related to such risks or casualties, such as fire, windstorm, hail, theft, boat-related losses or liabilities, tornado, host liquor liability, personal liability, firearm-related losses or liabilities, falling objects, vandalism, lightning, identity theft, earthquakes, jewelry loss or theft, power outage-related losses, extended dwelling coverage, personal injuries, medical expenses, backup of sewers, increase of ordinances/law, spoilage, equipment breakdowns, home business losses or liabilities, fine art loss or damage, volunteer-related losses or liabilities, loss assessment-related costs, golf cart liability or losses, incidental farming-related liability or losses, and landlord's furnishing-related losses. These examples are not exhaustive, however, and other coverage types may be available. In some embodiments, coverage types available to the insuree may be determined with reference to the insuree's age, health, medical history, driving history, family history, marital or family status, income, geographical location, or other factors.

In some embodiments, coverage packages encompassing one or more coverage types may be available. For example, packages containing essential coverages that are broadly recommended may be available. Premium or enhanced packages containing additional coverage types and/or having higher coverage limits may also be available.

At step 106, a graphical indicator associated with the at least one type of coverage available to the insuree is identified. In some embodiments, graphical indicators can be generated at 106 and associated with specific ones of the available coverages. For example, based on the type of casualty being insured against a graphical element can be generated to visually identify the type of casualty (e.g., fire for fire loss, waves for flood, etc.). In some embodiments, the association of graphical indicators and coverage type may be configurable based on default settings that can be changed, for example, by an administrator or in some examples, by a user. According to some embodiments, the graphical indicators may be associated with coverage types by the insurance carrier, by an insurance agent, by a system administrator, or anyone else with the authorization to do so.

At step 108, the graphical indicator is displayed. In some embodiments, a plurality of graphical indicators is displayed, each associated with a type of coverage that may be available, that may be provided to a specific user, or that are displayed for comparison purposes. The plurality of graphical indicators can be used to generate a coverage report for displayed to the user. In some embodiments, the report may be presented on a computer display, for example, a monitor. In other embodiments, the report may be printed by a printer attached to a computer. Various reports can be generated on the system including, for example, reports for providing information on existing policies through collections of graphical indicators, reports for subscribing for new insurance policies, and/or reports for comparing insurance policies.

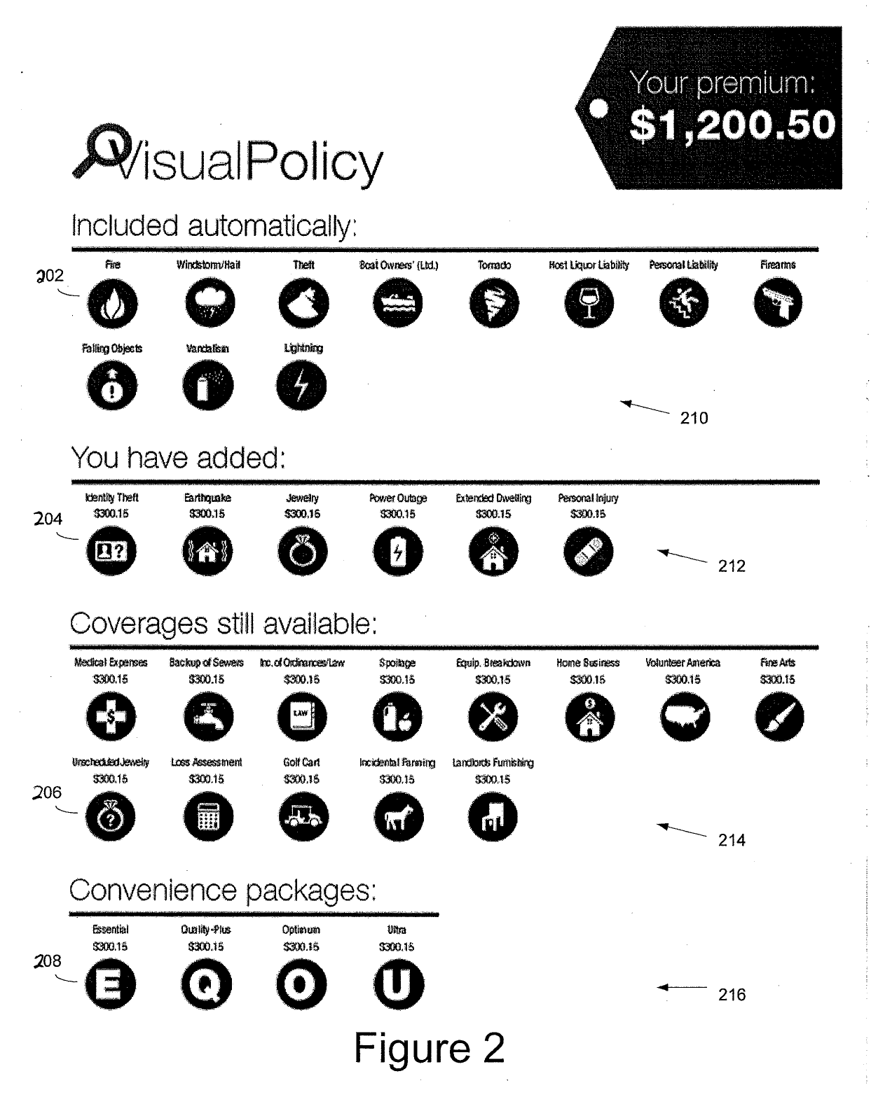

An exemplary report 200 can be seen in FIG. 2. The report 200 may include one or more of icons 202, 204, 206, 208 representing coverage types, and the icons may be displayed in one or more regions 210, 212, 214, 216.

Icons 202, 204, 206, 208 may represent coverage types in any number of ways. For example, icons 202, 204, 206, 208 may display pictures, diagrams, words, or other indicators that evoke the coverage type, the casualty against which the coverage protects, or other relevant feature. In some embodiments, icons 202, 204, 206, 208 may use text, either alone or in combination with a graphic, to evoke the coverage type, casualty, or other feature. For example, icon 202 displays a graphic representation of a fire, accompanied by the word “fire.” Icon 204 displays a graphic representation of an identification card accompanied by the phrase “identity theft.” Icon 206 displays a graphical representation of jewelry, accompanied by the phrase “unscheduled jewelry.” Icon 208 displays an “E,” accompanied by the word “essential.” Various categories can be displayed in conjunction with coverage types, for example, essential, for coverages that are required. In automobile insurance, for example, various state agencies may define coverage requirements that can be associated with coverage types and categories like “essential.”

Each of the regions 210, 212, 214, 216 may correspond to a level of coverage currently available to the insuree. For example, region 210 reflects coverage types included automatically in the policy associated with the insuree. Region 212 reflects coverage types that, while not included in the policy, have been added by the insuree or others. Region 214 reflects coverage types that are not included in the policy, but which are available to be added to the policy. Region 216 reflects coverage packages that are not included in the policy, but which are available to be added to the policy.

Exemplary icon 202, associated with fire coverage as discussed above, is displayed in region 210, indicating that fire coverage is included automatically in the insuree's policy. Exemplary icon 204, associated with identity theft coverage as discussed above, is displayed in region 212, indicating that identity theft coverage has been added to the policy. Exemplary icon 206, associated with unscheduled jewelry coverage as discussed above, is displayed in region 214, indicating that unscheduled jewelry coverage is available to be added to the policy. Exemplary icon 208, representing an essential coverage package as discussed above, indicating that the essential coverage package can be added to the policy.

The report 200 may be displayed on a display device (such as a computer monitor, on a mobile device display, tablet, etc.), or may also be printed by a printer. In other embodiments, the report 200, or instructions for accessing the graphical report, may be delivered by email, text message, webpage, or other computer-based technique. The report 200 may group graphical indicators based on the level of coverage held for the associated coverage type. For example, the report 200 may be separated into different regions, with one region showing icons for coverage types currently held by the insuree. In some embodiments, icons may be separated according to whether the coverage is included with the insuree's policy, or is an add-on. A different region may display coverage types not currently held by the insuree but available for purchase.

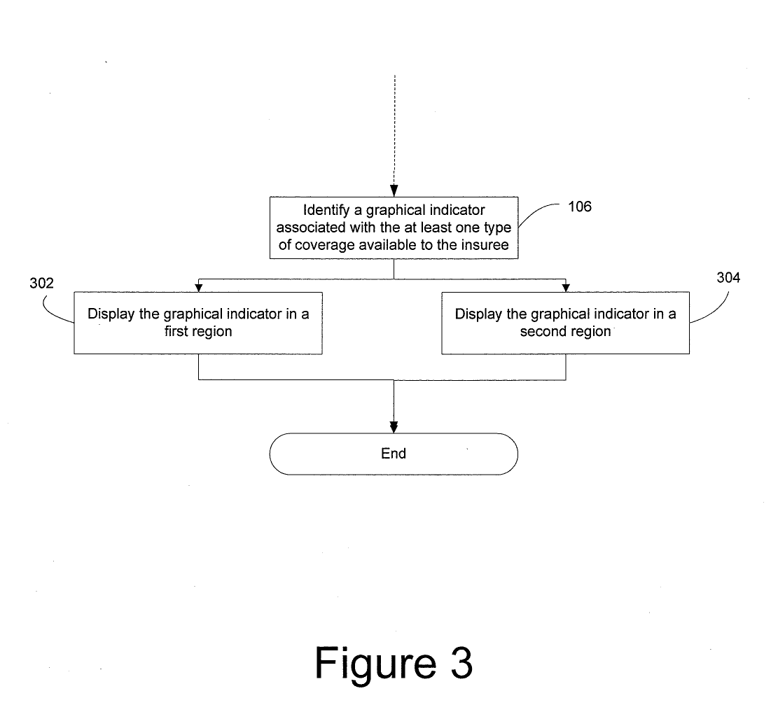

FIG. 3 shows a flowchart of a portion of a process 300 in accordance with one embodiment. As discussed above, the graphical indicator associated with the at least one type of coverage available to the insuree is identified in step 106. In step 302, responsive to the insuree maintaining the type of coverage associated with the graphical indicator, the graphical indicator is displayed in a first region. In step 304, responsive to the insuree not maintaining the type of coverage associated with the graphical indicator, the graphical indicator is displayed in a second region.

Returning to FIG. 2, in some embodiments, the graphical indicator is a graphical icon indicating that the insuree maintains the at least one type of coverage associated with the graphical indicator. In those embodiments, the icon may simply indicate whether the insuree has any amount of that type of coverage. In other embodiments, the icon may indicate other information about that type of coverage. The icon may include information about the amount, value, or cost of a particular type of coverage. For example, icon 204 displays the text “$300.15,” indicating that the insuree has added identity theft coverage for an additional premium of $300.15.

In some embodiments, the icon may graphically indicate an analysis of the amount of coverage currently held by the insuree. For example, the coverage report may use a color scheme to indicate that coverage is adequate, inadequate, or non-existent. For example, icons may be displayed in blue, indicating that coverage is adequate. Icons may be displayed in orange, indicating that, while the insuree is covered, that coverage may be inadequate. Icons may be displayed in red, showing that the insuree is not currently covered. In some embodiments, adequacy of the insuree's coverage may be determined with reference to the insuree's age, health, medical history, driving history, family history, marital or family status, income, geographical location, or any other factor used in performing a customized evaluation of insurance coverage. In other embodiments, the adequacy of the insuree's coverage may be determined by comparing the coverage amount to one or more predefined values, which may be configured by a system administrator.

In some embodiments, the user operating the graphical user interface that displays the graphical representation of the policy may select, within the interface, one or more controls that adjust parameters of the policy. Upon making a change, the system may display changes in the policy in real time to the user (e.g., including a change in the premium amount displayed within the interface). In addition, a user may be permitted to drag and drop coverage elements between regions (e.g., from an unselected region to a selected region) and can view resulting changes to the policy. In this way, changes to the policy may be easily viewed and compared.

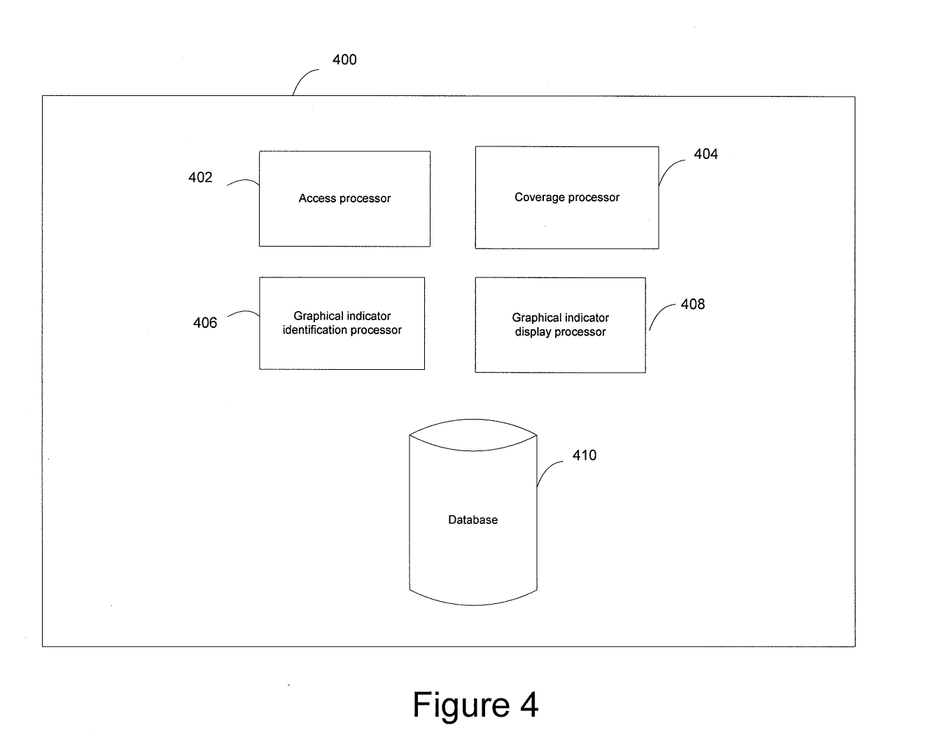

FIG. 4 shows an example block diagram of a system 400 configured to perform the described functions, processes, and/or embodiments. An access processor 402 is configured to access insurance policy information about an insuree in a coverage database. According to one embodiment, the access processor 402 can be configured to access insurance providers' sites available over the Internet. The access processor 402 can be configured to capture coverages from multiple providers' site individually and/or collectively. In some embodiments, the access processor can provide information from a user profile to the provider's sites to capture real time information on policy available, specific coverages, etc., tailored to the user's information.

According to one embodiment, a coverage processor 404 is configured to determine at least one type of coverage available to the insuree with reference to the insurance policy information, either from a coverage database or from available internet resources. In various embodiments, the coverage processor can be configured to generate a coverage database from the determined coverage. The database can store available coverages and the specific demographic information associated with the coverages. The database can be used for subsequent accesses for generating insurance policies displayed to users.

A graphical indicator identification processor 406 is configured to identify a graphical indicator associated with the at least one type of coverage available to the insuree. In some embodiments, the graphical indicator identification processor can be configured to identify a plurality of graphical indicators with a plurality of types of coverages available. In further embodiments, the graphical indicator identification processor 406 can identify a graphical indicator for a group of coverage or for specific policies.

According to one embodiment, a graphical indicator display processor 408 is configured to display the graphical indicator identified by the graphical indicator processor 406. In some embodiments, the graphical indicator processor can store identifications of the graphical indicators for each type of coverage in a database for subsequent access. In some examples, the graphical indicator display processor 408 can retrieve graphical indicators stored in the database.

In some embodiments, two or more of the access processor 402, the coverage processor 404, the graphical indicator identification processor 406, and the graphical indicator display processor 408 may be embodied on the same processor, and may include software components performed on a general purpose computer. In some embodiments, the processors and functions discussed can be implemented more generally on a specially configured general purpose computer that performs the respective functions discussed.

According to one embodiment, a database 410 is configured to store insurance coverage information. The database can include such information as the name of the insuree, types and amounts of coverage in the insuree's policy, types and amounts of coverage available to the insuree, and the term of coverage for each policy. In some embodiments, the database 410 can be implemented as one of a variety of database architectures. In further embodiments, database 410 can be implemented on a distributed data architecture. In one example, database 410 can include one or more database servers that host a plurality of database instances. Each of the database instances can be configured to store portions of insurance coverage information, graphical indicators associated with coverage types, system settings, thresholds for evaluating sufficiency of coverage, etc.

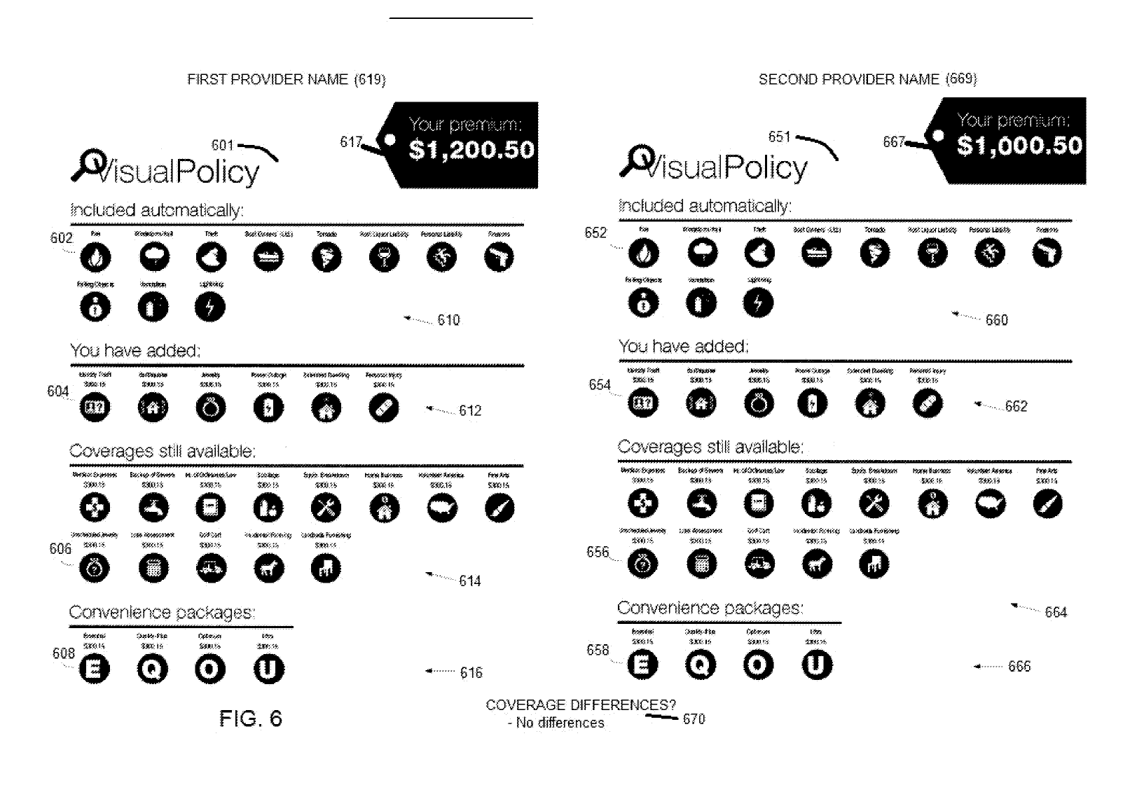

Shown in FIG. 6 is an example of a side by side comparison view. FIG. 6 includes comparison view 600, which provides graphical indicators identified and associated with two different providers. In some embodiments, additional providers can also be displayed in a comparison view. For example, comparison view 600 can include drop down menus for selecting specific providers for comparison. In some examples, the system enables the user to add and remove coverages offered through the selected providers through associated graphical indicators. In some embodiments, the addition and removal of graphical indicators causes the system to recalculate policy information dynamically. In further embodiments, the system is configured to analyze selected coverages to provide information associated with any difference in coverage levels. For example, a summary display at 670 can specify any difference in coverage level that would results in the difference in price displayed, for example, at 617 and 667.

Shown in display 600 are two reports 601 and 651. The reports may include one or more of icons 602, 604, 606, 608 and 652, 654, 656, 658, representing coverage types, and the icons may be displayed in one or more regions 610, 612, 614, 616 and 660, 662, 664, and 666.

Similar to report 200, icons 602-608 and 652-658 may represent coverage types in any number of ways. For example, icons 602-608 may display pictures, diagrams, words, or other indicators that evoke the coverage type, the casualty against which the coverage protects, or other relevant feature. Further, icons 652-658 display coverage information in the same way to allow the user to understand visually the differences in coverages available and the potential for savings. In some embodiments, the icons displayed at 602-608 and 652-658 can be displayed with colors reflective of difference levels of coverage associated with each coverage type. In addition to visually displaying information on coverage information for comparison between providers, the colors associated with each icon can further reflect a higher, equal, or lower level of coverage, relative to another level of coverage of the same type in the same display (e.g., 600).

Similar to report 200, as discussed above, icons 602-608 and 652-658 may use text, either alone or in combination with a graphic, to evoke the coverage type, casualty, or other feature. For example, icon 202 displays a graphic representation of a fire, accompanied by the word “fire.” Icon 604 displays a graphic representation of an identification card accompanied by the phrase “identity theft.” Icon 606 displays a graphical representation of jewelry, accompanied by the phrase “unscheduled jewelry.” Icon 608 displays an “E,” accompanied by the word “essential.” “E” and the coverages associated with an “essential” category may vary by provider, and may also vary based on the coverage being sought (e.g., automobile coverage, home owners insurance, life insurance, etc.). Various categories can be displayed in conjunction with coverage types. Each category can be displayed side by side for coverages provided by a plurality of providers.

Each of the regions 610-616 and 660-666 may correspond to a level of coverage currently available to the insuree (e.g., being offered by one or more providers). The level of coverages currently available to the insuree can be established based, for example, on offer information obtained from provider web-sites. In some embodiments, the level of coverages and cost can be tailored to the current user, for example, based on the current user's demographic information. According to one embodiment, the region 610 and corresponding region 660 reflect coverage types included automatically in the policy associated with the insuree. Regions 612/662 reflect coverage types that, while not included in the policy, have been added by the insuree or others. Regions 614/664 reflect coverage types that are not included in the policy, but which are available to be added to the policy. Regions 616/666 reflect coverage packages that are not included in the policy, but which are available to be added to the policy.

In one example, icon 602 is associated with fire coverage as discussed above, and displayed in region 610, indicating that fire coverage is included automatically in the insuree's policy from a first provider whose name is displayed at 619. The icon 652 is associated with fire coverage, and can be displayed in region 660, indicating that fire coverage is included automatically in the insuree's policy from a second provider whose name is displayed at 669. The icon 652 corresponds to 602 and can be displayed in the same position within a corresponding region (e.g., 660) to facilitate visual review and understanding of policy options.

According to some embodiments, the user is able to add and remove coverages in the side by side display and view any impact on policy premium (e.g., 617 and 667) across a plurality of insurance providers. In some examples, different providers may provide different levels of coverage for a variety of coverage types. The system is configured to analyze displayed coverages across a plurality of providers to determine colors to associate with each displayed coverage where more than one coverage is provided by different providers. For example, an icon can be displayed without color when a corresponding icon reflective of the same coverage by a different provider is associated with the same level of coverage (e.g., icons in regions 610 and 660 can be displayed without color responsive to the system determining that corresponding icons (i.e., reflective of the same type of coverage) provide the same or similar level of coverage). In another example, corresponding coverages provided by respective providers can be displayed in different colors, reflecting that one coverage level is superior to the other (e.g., a red icon for the lesser coverage level, and a green icon for the higher coverage level). In some embodiments, the user can selected an icon to access detailed information on the coverage type and/or to alter the coverage level associated with the icon.

The report 600 may be displayed on a display device (such as a computer monitor, on a mobile device display, tablet, etc.), or may also be printed by a printer. In other embodiments, the report 600, or instructions for accessing the graphical report, may be delivered by email, text message, webpage, or other computer-based technique. As discussed, the report 600 may group graphical indicators based on the level of coverage held for the associated coverage type. For example, the report 600 may be separated into different regions, with one region showing icons for coverage types currently held by the insuree. In some embodiments, icons may be separated according to whether the coverage is included with the insuree's policy, or is an add-on. A different region may display coverage types not currently held by the insuree but available for purchase.

In some embodiments, side by side views can be configured to allow the user to combine coverages from multiple providers into a single policy display and associated total cost. In some examples, the side by side display can include three sections. In one example, the three sections can be divided into two outer portions for displaying available coverage options. A third area in the middle can provide a current policy view showing the selections the user has elected for their current coverages. The system can provide a seamless interface for the user to drag and drop coverages from multiple providers to generate their own policy. The system can be configured to manage the actual purchase and contracting between the multiple providers. According to some embodiments, the system provides the user a single access point to interface with the multiple providers.

According to some embodiment, the side by side display can also be configured to display multiple categories of coverage in different sections of the display. For example, auto coverage can be displayed in one section, and home owner's insurance in another section (from one or multiple providers). In further embodiments, the system is configured to identify discounts or deductions for purchase of multiple insurance policies or coverages in multiple insurance categories. The system can provide indicators or message windows explicitly describing opportunities for discounts. In some embodiments, the system can track an display discounts that current selections are qualified for, and reflect any discounts in a current policy pricing display. In some examples, the system can be configured to suggest additional coverage opportunities that could provide discounts (e.g., consider life insurance policy in combination with auto or home policies, etc.).

### Example Computer Implementations

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

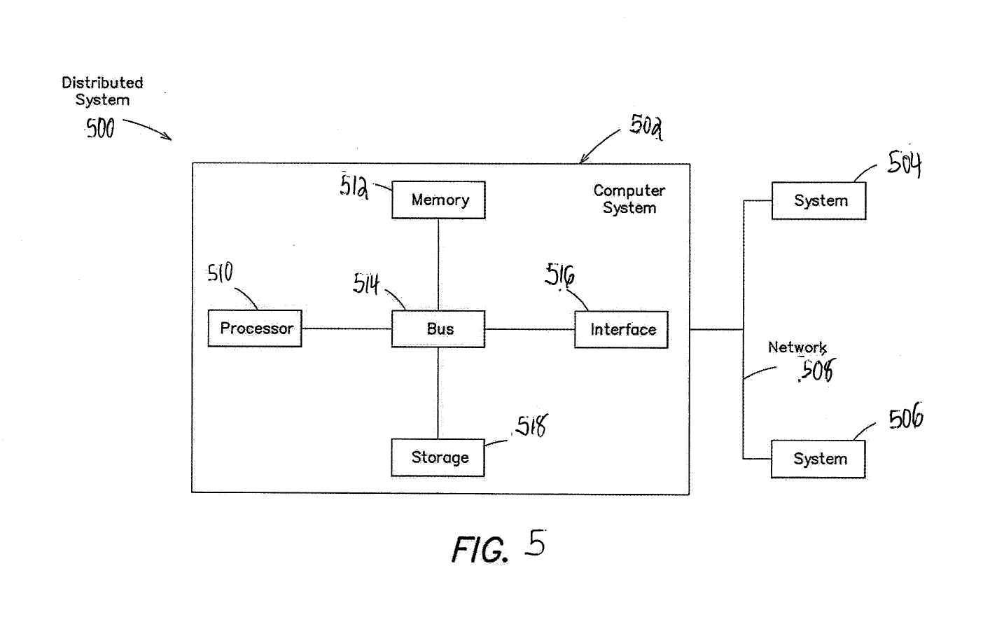

FIG. 5 shows a block diagram of a distributed computer system 500, in which various aspects and functions in accord with the present invention may be practiced. The distributed computer system 500 may include one more computer systems. For example, as illustrated, the distributed computer system 500 includes three computer systems 502, 504 and 506. As shown, the computer systems 502, 504 and 506 are interconnected by, and may exchange data through, a communication network 508. The network 508 may include any communication network through which computer systems may exchange data. To exchange data via the network 508, the computer systems 502, 504 and 506 and the network 508 may use various methods, protocols and standards including, among others, token ring, Ethernet, Wireless Ethernet, Bluetooth, TCP/IP, UDP, HTTP, FTP, SNMP, SMS, MMS, SSB, JSON, XML, REST, SOAP, CORBA HOP, RMI, DCOM and Web Services. To ensure data transfer is secure, the computer systems 502, 504 and 506 may transmit data via the network 508 using a variety of security measures including TSL, SSL or VPN, among other security techniques. While the distributed computer system 500 illustrates three networked computer systems, the distributed computer system 500 may include any number of computer systems, networked using any medium and communication protocol.

Various aspects and functions in accord with the present invention may be implemented as specialized hardware or software executing in one or more computer systems including the computer system 502 shown in FIG. 5. As depicted, the computer system 502 includes a processor 510, a memory 512, a bus 514, an interface 516 and a storage system 518. The processor 510, which may include one or more microprocessors or other types of controllers, can perform a series of instructions that manipulate data. The processor 510 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 510 is connected to other system placements, including a memory 512, by the bus 514.

The memory 512 may be used for storing programs and data during operation of the computer system 502. Thus, the memory 512 may be a relatively high performance, volatile, random access memory such as a dynamic random access memory (DRAM) or static memory (SRAM). However, the memory 512 may include any device for storing data, such as a disk drive or other non-volatile storage device, such as flash memory or phase-change memory (PCM). Various embodiments in accord with the present invention can organize the memory 512 into particularized and, in some cases, unique structures to perform the aspects and functions disclosed herein.

Components of the computer system 502 may be coupled by an interconnection element such as the bus 514. The bus 514 may include one or more physical busses (for example, busses between components that are integrated within a same machine), and may include any communication coupling between system placements including specialized or standard computing bus technologies such as IDE, SCSI, PCI and InfiniBand. Thus, the bus 514 enables communications (for example, data and instructions) to be exchanged between system components of the computer system 502.

Computer system 502 also includes one or more interface devices 516 such as input devices, output devices and combination input/output devices. The interface devices 516 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 516 allow the computer system 502 to exchange information and communicate with external entities, such as users and other systems.

Storage system 518 may include a computer-readable and computer-writeable nonvolatile storage medium in which instructions are stored that define a program to be executed by the processor. The storage system 518 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 510 or some other controller may cause data to be read from the nonvolatile recording medium into another memory, such as the memory 512, that allows for faster access to the information by the processor 510 than does the storage medium included in the storage system 518. The memory may be located in the storage system 518 or in the memory 512. The processor 510 may manipulate the data within the memory 512, and then copy the data to the medium associated with the storage system 518 after processing is completed. A variety of components may manage data movement between the medium and the memory 512, and the invention is not limited thereto.

Further, the invention is not limited to a particular memory system or storage system. Although the computer system 502 is shown by way of example as one type of computer system upon which various aspects and functions in accord with the present invention may be practiced, aspects of the invention are not limited to being implemented on the computer system, shown in FIG. 5. Various aspects and functions in accord with the present invention may be practiced on one or more computers having different architectures or components than that shown in FIG. 5. For instance, the computer system 502 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 502 may include an operating system that manages at least a portion of the hardware placements included in computer system 502. A processor or controller, such as processor 510, may execute an operating system which may be, among others, a Windows-based operating system (for example, Windows NT, Windows 2000/ME, Windows XP, Windows 8, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

In addition, the method described herein may be incorporated into other hardware and/or software products, such as a website, a mobile device, or a navigation unit.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer implemented method for graphically displaying insurance coverage information, comprising acts of:
accessing, by a computer system, insurance policy information about an insuree in a coverage database;
determining, by the computer system, with reference to the insurance policy information, at least one type of coverage available to the insuree;
identifying, by the computer system, a graphical indicator associated with the at least one type of coverage available to the insuree; and
displaying, by the computer system, the graphical indicator.

2. The method of claim 1, wherein the act of accessing insurance policy information about an insuree in a coverage database comprises accessing insurance policy information over a computer network.

3. The method of claim 1, further comprising an act of generating a coverage report displaying the graphical indicator.

4. The method of claim 3, wherein the act of generating the coverage report displaying the graphical indicator comprises acts of:
responsive to the insuree maintaining the type of coverage associated with the graphical indicator, displaying the graphical indicator in a first region; and
responsive to the insuree not maintaining the type of coverage associated with the graphical indicator, displaying the graphical indicator in a second region.

5. The method of claim 4, further comprising transitioning graphical indicator between the first and second regions responsive to user selection in a user interface.

6. The method of claim 3, further comprising an act of displaying the coverage report on a display device of a computer.

7. The method of claim 3, further comprising an act of printing the coverage report.

8. The method of claim 1, further comprising generating the graphical indicator including an image reflective of a type of coverage.

9. The method of claim 8, wherein generating the graphical indicator includes summarizing available coverage information as part of the graphical indicator.

10. The method of claim 9, wherein summarizing the available coverage information includes providing a display color for the graphical indicator reflective of a level of coverage.

11-15. (canceled)

16. A computer system for graphically displaying insurance coverage information, comprising:
an access processor configured to access insurance policy information about an insuree in a coverage database;
a coverage processor configured to determine, with reference to the insurance policy information, at least one type of coverage available to the insuree;
a graphical indicator identification processor configured to identify a graphical indicator associated with the at least one type of coverage available to the insuree; and
a graphical indicator display processor configured to display the graphical indicator.

17. The system of claim 16, wherein the access processor is configured to access insurance policy information over a computer network.

18. The system of claim 16, wherein the coverage processor is configured to generate a coverage report displaying the graphical indicator.

19. The system of claim 18, wherein the coverage processor is configured to generate the coverage report responsive to the insuree maintaining the type of coverage associated with the graphical indicator, having the graphical indicator displayed in a first region, and responsive to the insuree not maintaining the type of coverage associated with the graphical indicator, having the graphical indicator displayed in a second region.

20. The system of claim 19, wherein the coverage processor is configured to transition the graphical indicator between the first and second regions responsive to user selection in a user interface.

21. The system of claim 18, wherein the coverage processor is configured to display the coverage report on a display device of a computer.

22. The system of claim 18, wherein the coverage processor is configured to generate a printable image of the coverage report.

23. The system of claim 16, wherein the graphical indicator display processor is configured to generate the graphical indicator including an image reflective of a type of coverage.

24. The system of claim 23, wherein the graphical indicator display processor is configured to summarize available coverage information as part of the graphical indicator.

25. The system stem of claim 24, a graphical indicator display processor is configured to provide a display color for the graphical indicator reflective of a level of coverage to summarize the available coverage information.

26-32. (canceled)
